(19) United States
(12) Patent Application Publication
(10) Pub. No.: US 2025/0100276 A1
(43) Pub. Date: Mar. 27, 2025

(54) LIQUID EJECTION HEAD AND LIQUID EJECTION APPARATUS

(71) Applicant: CANON KABUSHIKI KAISHA, Tokyo (JP)

(72) Inventor: TAKUMA KODOI, Kanagawa (JP)

(21) Appl. No.: 18/897,781

(22) Filed: Sep. 26, 2024

(30) Foreign Application Priority Data
Sep. 27, 2023 (JP) 2023-164220

(51) Int. Cl. B41J 2/14; B41J 2/175

(52) U.S. Cl. CPC B41J 2/14; B41J 2/17563; B41J 2002/14491; B41J 2202/18

(57) ABSTRACT

To provide a liquid ejection head capable of implementing both improvement of reliability and downsizing at the same time. The liquid ejection head comprises an element substrate ejecting liquid, an electrical wiring substrate electrically connected to the element substrate, and a liquid storage portion configured to store liquid to be supplied to the element substrate. On the first face of the electrical wiring substrate, an electrical part generating heat in a case where power input from the outside for ejecting liquid is controlled is provided. The liquid storage portion is provided on the first face side of the electrical wiring substrate. The electrical part and the liquid storage portion are not provided at positions opposite to each other in a case of being viewed from a direction perpendicular to the first face.

### BACKGROUND

### Field of the Disclosure

The present disclosure relates to a liquid ejection head and a liquid ejection apparatus.

### Description of the Related Art

Japanese Patent Laid-Open No. 2019-014110 has disclosed a liquid ejection head in which a signal input unit and a power input unit to which high-potential power is input are arranged on the sides opposite to each other with a center line perpendicular to the longitudinal direction of an electrical wiring substrate being sandwiched in between. According to the liquid ejection head of Japanese Patent Laid-Open No. 2019-014110, it is possible to arrange a wiring line connected to the power input unit and a wiring line connected to the signal input unit at positions distant from each other, and therefore, a reduction in the influence of noise on a control signal is implemented.

Further, there is a case where a liquid ejection head capable of circulating liquid inside the liquid ejection head comprises a negative pressure control unit for controlling a negative pressure in circulating liquid. In the situation such as this, it is attempted to arrange the power input unit and the negative pressure control unit on the same side with the electrical wiring substrate as a boundary in order to downsize the liquid ejection head.

However, in a case where a predetermined part provided on the electrical wiring substrate and the negative pressure control unit are arranged on the same side with the electrical wiring substrate as a boundary, there is a possibility that the part and the negative pressure control unit interfere with each other.

### SUMMARY

Consequently, an object of the present disclosure is to provide a liquid ejection head capable of implementing both improvement of reliability and downsizing at the same time.

The liquid ejection head according to the present disclosure includes: an element substrate ejecting liquid; an electrical wiring substrate electrically connected to the element substrate; and a liquid storage portion configured to store liquid to be supplied to the element substrate, wherein on a first face of the electrical wiring substrate, an electrical part generating heat in a case where power input from the outside for ejecting liquid is controlled is provided, the liquid storage portion is provided on the first face side of the electrical wiring substrate, and the electrical part and the liquid storage portion are not provided at positions opposite to each other in a case of being viewed from a direction perpendicular to the first face.

Further features of the present disclosure will become apparent from the following description of exemplary embodiments with reference to the attached drawings.

### BRIEF DESCRIPTION OF THE DRAWINGS

FIG. 1 is a diagram showing a schematic configuration of a liquid ejection apparatus in one embodiment;

FIG. 2 is a diagram showing one example of a circulation path in one embodiment;

FIG. 3 is an exploded perspective diagram of a liquid ejection head in one embodiment;

FIG. 4A is a perspective diagram of a liquid ejection head in one embodiment;

FIG. 4B is a perspective diagram of a liquid ejection head in one embodiment;

FIG. 5 is a schematic cross-sectional diagram of a liquid ejection head in one embodiment;

FIG. 6 is a schematic cross-sectional diagram of a liquid ejection head in a comparative example;

FIG. 7A is a perspective diagram of a liquid ejection head on which a cover is mounted in one embodiment; and

FIG. 7B is a transparent perspective diagram of a liquid ejection head on which a cover is mounted in one embodiment.

### DESCRIPTION OF THE EMBODIMENTS

### First Embodiment

### <Whole Configuration of Printing Apparatus>

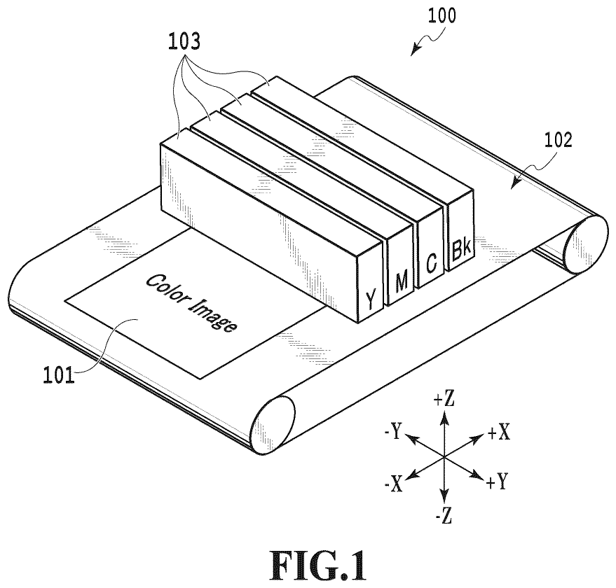

FIG. 1 is a diagram showing a schematic configuration of a liquid ejection apparatus 100.

Coordinate axes in the drawings are explained. In the drawings referred to in the present specification, the X-direction and the Y-direction indicate two directions perpendicular to each other on a horizontal plane. The Z-direction indicates the vertical direction. The +X-direction indicates the backward direction of a liquid ejection head 103, the −X-direction indicates the forward direction, the +Y-direction indicates the leftward direction, the −Y-direction indicates the rightward direction, the +Z-direction indicates the upward direction, and the −Z-direction indicates the downward direction, respectively. The −X-direction also indicates the downstream side in the conveyance direction of a printing medium 101 and the +X-direction also indicates the upstream side in the conveyance direction of the printing medium 101. The X-direction is called the conveyance direction as appropriate. Further, the Y-direction is the longitudinal direction (width direction) of the liquid ejection head 103, the X-direction is the transverse direction (depth direction) of the liquid ejection head 103, and the Z-direction is the height direction of the liquid ejection head 103. In the following explanation. unless described particularly, the upward, downward, leftward, and rightward directions indicate directions in the posture in which the liquid ejection head 103 is used in the normal state.

In the present embodiment, explanation is given on the assumption that “liquid” is ink. However, the liquid that can be used in the present embodiment is not limited to ink. That is, as the liquid, it may also be possible to use various printing liquids including a processing liquid or the like that is used for the purpose of improving the fixing property of ink in a printing medium, reducing gloss unevenness, or improving scratch resistance.

“Printing” means not only forming significant information, such as a character and graphics. “Printing” also means forming meaningless information, such as an image or pattern. Further, “printing” is irrespective of whether or not visualization is performed so as to enable visual perception by a human being. That is, “printing” also means forming a structure for a printing medium or modifying a medium.

As shown in FIG. 1, the liquid ejection apparatus 100 comprises a conveyance unit 102 configured to convey the printing medium 101 and the line liquid ejection head 103 arranged substantially perpendicular to the conveyance direction of the printing medium 101.

In the present embodiment, the line liquid ejection apparatus 100 is used, which performs continuous printing by one pass while conveying a plurality of the printing media 101 continuously or intermittently. As the printing medium 101, a cut sheet is used. The printing medium 101 is not limited to a cut sheet and may be continuous roll paper or a film. The liquid ejection apparatus 100 comprises the four liquid ejection heads 103 for a single color corresponding to each of four kinds of yellow, magenta, cyan, and black inks. Each of “Y”, “M”, “C”, and “Bk” in FIG. 1 indicates each of yellow, magenta, cyan, and black. As described above, in the present embodiment, printing is completed by the printing medium 101 moving under the liquid ejection head 103, not by the liquid ejection head 103 moving.

Further, it is possible for the liquid ejection apparatus 100 to circulate ink inside the liquid ejection head 103. By circulating ink inside the liquid ejection head 103, it is possible to suppress the occurrence of ejection failure caused by ink evaporating from the ejection port and thickening.

### <Circulation Path of Liquid>

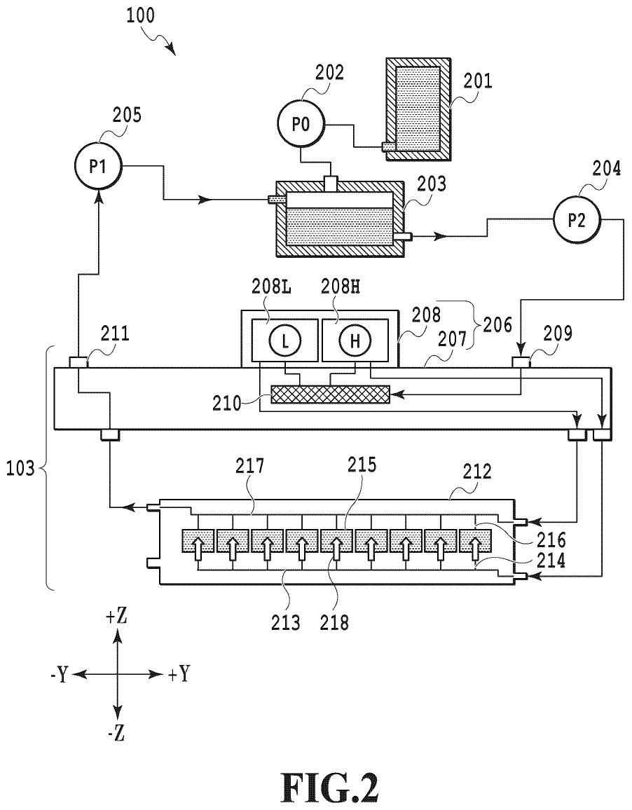

FIG. 2 is a diagram showing one example of a circulation path that can be applied to the present embodiment. In FIG. 2, for simplification of explanation, only the path is shown in which the ink of one color among the above-described four colors circulates. However, the main body of the liquid ejection apparatus 100 is provided with the circulation paths for the above-described four colors.

As shown in FIG. 2, the liquid ejection apparatus 100 comprises a main tank 201 capable of storing ink, a replenishing pump 202 capable of sending ink, and a buffer tank 203 functioning as a sub tank. The liquid ejection apparatus 100 comprises a first circulation pump 205 for collecting ink to the buffer tank 203 from the liquid ejection head 103 and a second circulation pump 204 for supplying ink to the liquid ejection head 103 from the buffer tank 203. The liquid ejection head 103 comprises a liquid storage portion 206 capable of temporarily storing liquid during the circulation of liquid.

The liquid storage portion 206 includes a liquid supply unit 207 capable of being supplied with ink from the second circulation pump 204 and a negative pressure control unit 208 capable of controlling negative pressure. The liquid supply unit 207 is a filter unit comprising an inlet 209 for introducing ink into the liquid ejection head 103, a filter 210 for removing foreign matter in ink, and an outlet 211 for discharging ink from the liquid ejection head 103.

The filter 210 is provided as to be capable of causing liquid to pass from the inlet 209 provided on one side of the liquid supply unit 207 to the negative pressure control unit 208 arranged on the liquid supply unit 207. Due to the filter 210, it is possible to prevent foreign matter, such as dust, from flowing downstream beyond the liquid supply unit 207.

The liquid ejection head 103 comprises a liquid ejection unit 212 for ejecting ink. The liquid ejection unit 212 comprises a common supply channel 213 that is supplied with ink from the liquid storage portion 206 and a plurality of individual supply channels 214 connected to the one common supply channel 213. The liquid ejection unit 212 comprises a plurality of element substrates 215 connected to each of the plurality of the individual supply channels 214. The liquid ejection unit 212 comprises a plurality of individual collecting channels 216 connected to each of the plurality of the element substrates 215 and one common collecting channel 217 connected to each of the plurality of the individual collecting channels 216.

The first circulation pump 205 has a function of sucking in liquid from the outlet 211 of the liquid ejection unit 212 and returning the liquid to the buffer tank 203. While the liquid ejection head 103 is driving, a predetermined amount of ink flows inside the common collecting channel 217 by the first circulation pump 205.

It is possible for the buffer tank 203 connected to the main tank 201 via the replenishing pump 202 to store ink. The buffer tank 203 has an atmosphere communication opening (not shown schematically) through which air passes from inside to outside. It is possible for the buffer tank 203 to discharge air bubbles in ink to the outside through the atmosphere communication opening. The replenishing pump 202 sends ink corresponding to an amount of ink consumed in the liquid ejection head 103 from the main tank 201 to the buffer tank 203. Ink is consumed by being ejected from the ejection port of the element substrate 215, for example, during printing, suction recovery and the like.

The negative pressure control unit 208 is provided between the second circulation pump 204 and the liquid ejection unit 212. The negative pressure control unit 208 is configured so as to be capable of performing pressure control for supplying ink having passed through the filter 210 to the liquid ejection unit 212. The negative pressure control unit 208 has a function of operating so as to maintain the pressure on the downstream side (that is, on the side of the liquid ejection unit 212) of the negative pressure control unit 208 at a predetermined pressure set in advance even in a case where the flow rate of the circulation system fluctuates due to a difference in the duty with which printing is performed.

Inside the negative pressure control unit 208, a first pressure adjustment mechanism 208H and a second pressure adjustment mechanism 208L are provided. Each of the first pressure adjustment mechanism 208H and the second pressure adjustment mechanism 208L is set to a different control pressure. In each of the first pressure adjustment mechanism 208H and the second pressure adjustment mechanism 208L, a pressure adjustment valve, a spring and the like are incorporated.

By the workings of these pressure adjustment valve, the spring and the like, the change in the pressure loss inside the supply system (supply system on the upstream side of the liquid ejection head 103) of the liquid ejection apparatus 100, which occurs accompanying the fluctuations of the flow rate of liquid, is attenuated considerably. Due to this, it is possible to stabilize the change in the negative pressure on the downstream side (on the side of the liquid ejection unit 212) of the negative pressure control unit 208 within a certain predetermined range.

The liquid ejection unit 212 is provided with the common supply channel 213, the common collecting channel 217, and the individual supply channel 214 and the individual collecting channel 216 both connected to each of the plurality of the element substrates 215. The individual supply channel 214 and the individual collecting channel 216 are connected to the common supply channel 213 and the common collecting channel 217.

Then, the first pressure adjustment mechanism 208H is connected to the common supply channel 213 via the liquid supply unit 207. The second pressure adjustment mechanism 208L is connected to the common collecting channel 217 via the liquid supply unit 207. As described above, there occurs a pressure difference between the two common channels, and therefore, a flow (flow indicated by an arrow 218 in FIG. 2) occurs, which is a flow of part of ink flowing from the common supply channel 213 to the common collecting channel 217 through the channel provided inside the element substrate 215.

In this manner, in the liquid ejection unit 212, a flow of liquid passing through the inside of the common collecting channel 217 and a flow flowing from the common supply channel 213 toward the common collecting channel 217 through the inside of each of the plurality of the element substrates 215 occur. By making use of these flows, it is possible to discharge heat generated by each of the plurality of the element substrates 215 to the outside of the element substrate 215.

Further, according to the configuration such as this, in a case where the liquid ejection head 103 is performing printing, it is possible to cause a flow of ink to occur also through the ejection port in the element substrate 215, for which printing is not performed, and in the pressure chamber. Because of this, it is possible to suppress thickening of ink at the ejection port and in the pressure chamber thereof. Then, it is possible to discharge the ink having thickened and foreign matter in the ink to the common collecting channel 217. Because of this, it is possible for the liquid ejection head 103 to maintain the performance of high-speed and high-image quality printing.

### <Liquid Ejection Head 103>

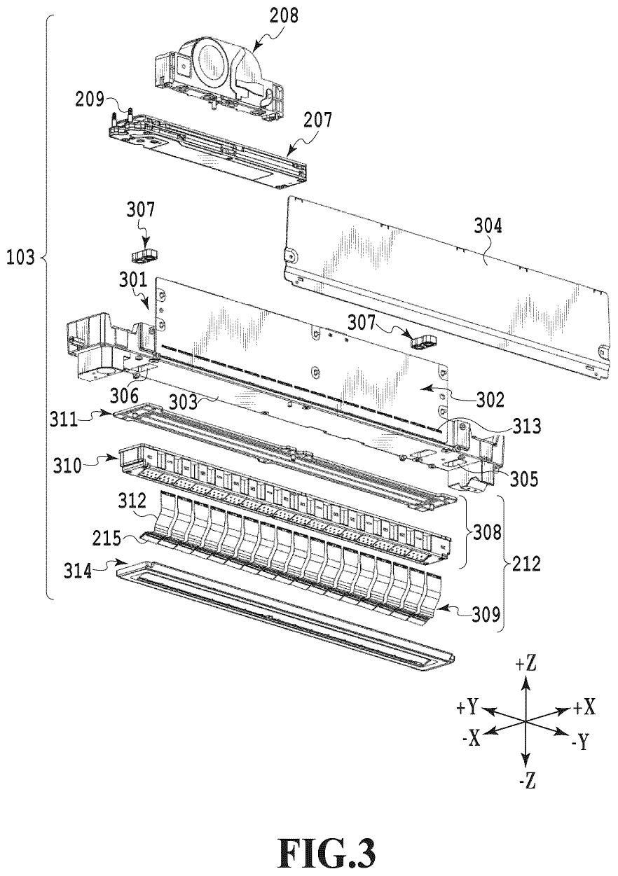

FIG. 3 is an exploded perspective diagram of the liquid ejection head 103.

As shown in FIG. 3, the liquid ejection head 103 comprises a casing 301. To the casing 301, the liquid ejection unit 212, the liquid supply unit 207, and an electrical wiring substrate 302 are attached. It is possible for the liquid supply unit 207 to supply liquid to the element substrate 215 via an opening provided in the casing 301.

The casing 301 includes a liquid ejection unit support portion 303 configured to support the liquid supply unit 207 and an electrical wiring substrate support portion 304 configured to support the electrical wiring substrate 302. The casing 301 secures rigidity of the liquid ejection head 103 as well as supporting the liquid ejection unit 212 and the electrical wiring substrate 302. The electrical wiring substrate support portion 304 is fixed with crews to the liquid ejection unit support portion 303.

The liquid ejection unit support portion 303 is provided with a first opening 305 and a second opening 306. Into the first opening 305 and the second opening 306, a joint rubber 307 is inserted. The liquid that is supplied from the liquid supply unit 207 passes through an opening provided in the joint rubber 307 inserted into the second opening 306 and is guided to the liquid ejection unit 212. In a case where liquid is circulated, the liquid passes through an opening provided in the joint rubber 307 inserted into the first opening 305 and is returned to the liquid supply unit 207 from the liquid ejection unit 212.

The liquid ejection unit 212 includes a channel unit 308 and a plurality of ejection modules 309. The channel unit 308 includes a first channel member 310 and a second channel member 311. The ejection module 309 includes the element substrate 215 and a flexible wiring substrate 312.

The element substrate 215 and the electrical wiring substrate 302 are electrically connected by the flexible wiring substrate 312. The end portion of the flexible wiring substrate 312 is connected to the element substrate 215. The other end portion of the flexible wiring substrate 312 is connected to a terminal 313 provided on the contact face of the electrical wiring substrate 302.

The channel unit 308 is configured by laminating the first channel member 310 and the second channel member 311. It is possible for the channel unit 308 to distribute the liquid supplied from the liquid supply unit 207 to each ejection module 309. It is also possible for the channel unit 308 to return the liquid that circulates from the ejection module 309 to the liquid supply unit 207. The channel unit 308 is fixed with screws to the liquid ejection unit support portion 303. By the channel unit 308 being fixed in this manner, the warp and deformation of the channel unit 308 are suppressed.

Further, to the liquid ejection unit 212, a face cover 314 is attached. In a case where the face cover 314 is attached to the liquid ejection unit 212, the element substrate 215 is exposed from an opening provided in the face cover 314. Due to the attachment of the face cover 314, the surface opposite to the printing medium 101 (see FIG. 1) is flattened and the unevenness of the air flow caused by conveyance and ejection is reduced and the landing accuracy of liquid droplets improves compared to the case where the face cover 314 is not attached. Due to the attachment of the face cover 314, the airtightness improves in a case where a cap (not shown schematically) is abutted while printing is not performed compared to the case where the face cover 314 is not attached. By improving the airtightness, it is possible to suppress thickening of ink caused by evaporation of moisture from the ejection port.

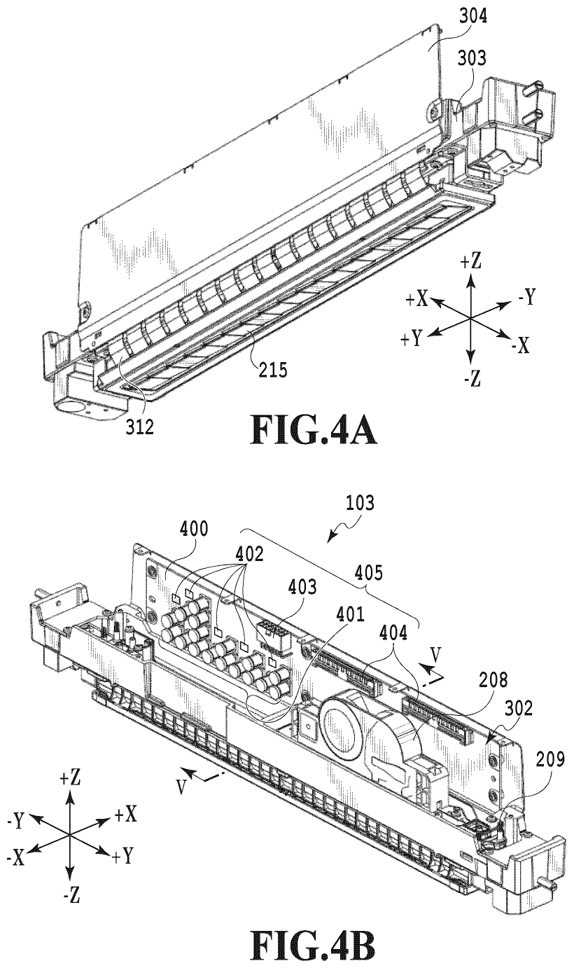

FIG. 4A and FIG. 4B are each a perspective diagram of the liquid ejection head 103 in the present embodiment.

As shown in FIG. 4A, in the present embodiment, the page-wide type liquid ejection head 103 is used, in which the 17 element substrates 215 are arrayed in-line along the longitudinal direction of the liquid ejection head 103. Further, the electrical wiring substrate support portion 304 is fixed with screws to the liquid ejection unit support portion 303.

As shown in FIG. 4B, on a first face 400 of the electrical wiring substrate 302, electrical parts that are utilized in a case where power input from the outside in order to eject liquid is controlled. On the first face 400, an electrical part group 405 including capacitors 401, transistors 402, a power supply terminal 403, and signal input terminals 404 is mounted.

The liquid storage portion 206 is provided on the side of the first face 400. However, the power supply terminal 403 and the liquid storage portion 206 are not provided at positions opposite to each other in a case of being viewed from the direction perpendicular to the first face 400. The power supply terminal 403 drives on a relatively high potential among a plurality of the electrical parts provided on the first face 400. To the power supply terminal 403, for example, a voltage of 10 V (volt) or higher is applied. The power supply terminal 403 is provided on the side opposite the side on which the liquid storage portion 206 is provided with the center in the longitudinal direction of the electrical wiring substrate 302 as a boundary.

On the electrical wiring substrate 302, the first face 400 faces in the direction opposite to the contact face to which the flexible wiring substrate 312 (see FIG. 4A) is connected. The first face 400 is provided with the capacitor 401 for suppressing the voltage drop of the element substrate 215. Specifically, as the capacitor 401, an aluminum electrolytic capacitor is used.

Further, the first face 400 is provided with the transistor 402 for controlling the capacitor 401. Specifically, as the transistor 402, a MOSFET (Metal-Oxide-Semiconductor Field Effect Transistor) is used. The first face 400 is also provided with a transistor (not shown schematically) different from the transistor 402. Then, the first face 400 is also provided with a capacitor (not shown schematically) different from the capacitor 401 for controlling the transistor (not shown schematically). In addition to those, the electrical wiring substrate 302 is provided with a multiplexer for controlling temperature. Further, the first face 400 is provided with other various IC (Integrated Circuit) parts. As one example of the IC part, there is an operational amplifier.

Further, the first face 400 is provided with the power supply terminal 403 and the signal input terminal 404, which are connected to the flexible wiring substrate 312 (see FIG. 3A) via wiring lines provided inside the electrical wiring substrate 302. To the power supply terminal 403, a wiring line transmitting power necessary for ejection is connected, which is transmitted from the control unit (for example, CPU not shown schematically) comprised by the main body of the liquid ejection apparatus 100 (see FIG. 1). The power is supplied to the element substrate 215 via the wiring line provided inside the electrical wiring substrate 302 and the flexible wiring substrate 312 (see FIG. 4A).

The element substrate 215 has a plurality of energy generation elements (for example, heating elements such as heaters) generating energy for ejecting liquid. Each of the plurality of energy generation elements is provided at the position corresponding to each of the plurality of ejection ports. By the energy generation element driving, liquid droplets are ejected from the ejection port. An electric signal (ejection signal) for driving the energy generation element is generated by the control unit (for example, CPU not shown schematically) comprised by the main body of the liquid ejection apparatus 100. The ejection signal is transmitted to the electrical wiring substrate 302 from the main body of the liquid ejection apparatus 100 via an electrical connecting member (for example, flexible wiring substrate not shown schematically).

To the signal input terminal 404, a wiring line transmitting an electric signal (ejection signal) necessary for ejection is connected, which is transmitted from the control unit (for example, CPU not shown schematically) comprised by the main body of the liquid ejection apparatus 100 (see FIG. 1). The ejection signal is supplied to the element substrate 215 via the wiring line provided inside the electrical wiring substrate 302 and the flexible wiring substrate 312 (see FIG. 4A).

The electrical wiring substrate 302 is a rigid substrate. As one example of the rigid substrate, there is a printed board. Inside the electrical wiring substrate 302, wiring lines are aggregated by an electrical circuit. By aggregating wiring lines as described above, it is possible to reduce the number of power supply terminals 403 and the number of signal input terminals 404 smaller than the number of element substrates 215. Consequently, compared to the case where the power supply terminals 403, the signal input terminals 404, and the element substrates 215 are the same in number, it is possible to reduce the number of electrical connection sections necessary for attaching/detaching the liquid ejection head 103 to and from the liquid ejection apparatus 100 (see FIG. 1).

As explained above, by the power and the electric signal being input to the electrical wiring substrate 302 from the power supply terminal 403 and the signal input terminal 404, the liquid ejection head 103 drives. Then, by the drive signal and the voltage being controlled by the wiring line and the circuit on the electrical wiring substrate 302, the element substrate 215 drives.

The circuit of the liquid ejection head 103 is divided into a circuit in a low-potential system and a circuit in a high-potential system. As one example of the circuit in a low-potential system, there is a logic-based circuit that operates on 3.3 V. As one example of the circuit in a high-potential system, there is a circuit for driving a sub heater and a heater, which drives on 10 V or higher.

The liquid ejection head 103 drives on a voltage of about 10 V to about 28 V and there is a case where one part consumes a power of several W (watt). There is a tendency for a part that drives by using a high voltage of 10 V or higher and a part such as a connector, through which a comparatively large current flows, to generate heat more than the other parts do. Particularly, there is a case where a large amount of heat is generated in the vicinity of the root of a connector through which a comparatively large current flows at a high potential of about 28 V.

In the present embodiment, a current of about 6 A (ampere) to about 10 A for driving the three element substrates 215 among the 17 element substrates 215 flows through one comparatively small terminal included in the power supply terminal 403. The power supply terminal 403 has six small terminals such as these, and therefore, in the vicinity of the power supply terminal 403, there is a case where a current of about 30 A to about 60 A flows. In a case where a comparatively large current such as this continues to flow through the power supply terminal 403, the power supply terminal 403 generates heat and there is a possibility that the surrounding atmosphere is heated.

In the situation such as this, in a case where the liquid storage portion 206 is arranged in the vicinity of the power supply terminal 403, it is considered that ink stored temporarily inside the liquid storage portion 206 is heated and evaporates into the air stagnant inside thereof, and the ink agglomerates.

Consequently, in the present embodiment, in order to suppress the agglomeration of ink inside the liquid storage portion 206, the part likely to generate heat is not arranged between the liquid storage portion 206 and the electrical wiring substrate 302.

The negative pressure control unit 208 is located on the same side as that of the power supply terminal 403 with the electrical wiring substrate 302 as a boundary and arranged at a position not opposite to the power supply terminal 403. The liquid storage portion 206 and the power supply terminal 403 are provided in the areas on the opposite sides with respect to substantially the center in the longitudinal direction on the first surface 400. That is, the power supply terminal 403 is provided at a position not opposite to the liquid storage portion 206.

According to the arrangement such as this, even in a case where the power supply terminal 403 and the liquid storage portion 206 are arranged on the same side as that of the electrical wiring substrate 302, it is possible to make the liquid storage portion 206 distant from the power supply terminal 403.

By making the power supply terminal 403 as distant as possible from the liquid storage portion 206, even in a case where the power supply terminal 403 generates heat, it is possible to make the heat hard to reach the liquid storage portion 206. As described above, according to the configuration of the present embodiment, the power supply terminal 403 and the liquid storage portion 206 are arranged at the positions distant from each other on the same side of that of the electrical wiring substrate 302. Due to this, it is possible to suppress ink from agglomerating inside the liquid storage portion 206 while downsizing the liquid ejection head 103.

On the first face 400, it is preferable for the part driving on a comparatively high potential also to be provided at a position as distant as possible from the liquid storage portion 206 irrespective of the magnitude of the power consumption (that is, heat generation amount). There is also a case where the liquid storage portion 206 breaks for some reason and ink leaks from the liquid storage portion 206. In this case, on a condition that ink sticks to the part driving on a high potential, there is a possibility that corrosion due to migration and leakage of current occur, resulting in burnout.

In the present embodiment, the transistor 402 is used for switching of the capacitor 401. The power consumption of the transistor 402 is comparatively low, but the transistor 402 drives on a comparatively high potential. Consequently, even though the heat generation amount of the transistor 402 is smaller than the heat generation amount of the power supply terminal 403, in a case where ink sticks to the transistor 402, there is a possibility that burnout is caused. Because of this, it is preferable for the transistor 402 also to be provided at a position not opposite to the liquid storage portion 206 like the power supply terminal 403.

As described above, the liquid storage portion 206 is arranged at the position opposite to the area from substantially the center in the longitudinal direction on the first face 400 to the end portion. The transistor 402 is provided in the area from substantially the center in the longitudinal direction on the first face 400 to the other end portion. That is, the transistor 402 is provided at the position not opposite to the liquid storage portion 206.

According to the arrangement such as this, it is possible to make distant the transistor 402 from the liquid storage portion 206 even in a case where the transistor 402 and the liquid storage portion 206 are arranged on the same side with the electrical wiring substrate 302 as a boundary. By making the transistor 402 as distant as possible from the liquid storage portion 206, even in a case where ink leaks from the liquid storage portion 206, it is possible to make it hard for the ink to stick to the transistor 402.

Consequently, according to the configuration of the present embodiment, by arranging the transistor 402 and the liquid storage portion 206 on the same side as that of the electrical wiring substrate 302, it is possible to downsize the liquid ejection head 103. Then, it is possible to suppress ink from sticking to the transistor 402.

In a case where there is a possibility that the capacitor 401 also generates heat and causes ink inside the liquid storage portion 206 to agglomerate, it is preferable for the capacitor 401 to be provided in the area from substantially the center in the longitudinal direction on the first face 400 to the other end portion. By making the capacitor 401 as distant as possible from the liquid storage portion 206, even in a case where the capacitor 401 generates heat, it is possible to suppress ink from agglomerating inside the liquid storage portion 206.

Further, on the first face 400, it is also preferable for the part having a comparatively large size not to be arranged between the liquid storage portion 206 and the electrical wiring substrate 302. For example, the main body portion of the capacitor 401 protrudes toward the side on which the liquid storage portion 206 is arranged with the electrical wiring substrate 302 as a boundary in a state where the capacitor 401 is mounted on the electrical wiring substrate 302. Consequently, it is preferable for the capacitor 401 (aluminum electrolytic capacitor) not to be arranged between the liquid storage portion 206 and the electrical wiring substrate 302.

Conventionally, it is general for the negative pressure control unit and the aluminum electrolytic capacitor to be arranged on the sides opposite to each other with an electrical wiring substrate being sandwiched in between. However, with the arrangement such as that, there is a possibility that the size of the liquid ejection head increases in the depth direction (X-direction), and therefore, the downsizing of the liquid ejection head is hindered.

As in the present embodiment, in a case where the comparatively large part (the capacitor 401) of the electrical wiring substrate 302 and the liquid storage portion 206 are arranged on the side in the same direction with the electrical wiring substrate 302 as a boundary, the arrangement such as this is essential. On the first face 400, the capacitor 401 is arranged so as not to be opposite to the liquid storage portion 206. In the present embodiment, the liquid storage portion 206 is arranged on one side (on the right side in FIG. 4B) with substantially the center in the longitudinal direction on the electrical wiring substrate 302 as a boundary and a plurality of the capacitors 401 is arranged on the opposite side (on the left side in FIG. 4B) collectively.

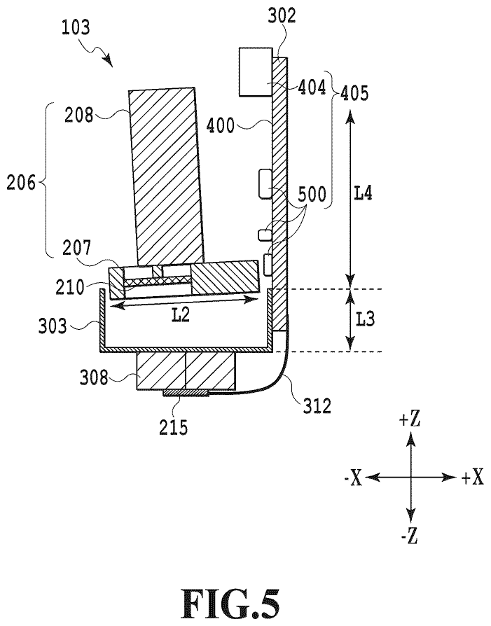

FIG. 5 is a cross-sectional diagram along a V-V line in FIG. 4B. In FIG. 5, the liquid storage portion 206 is about to be attached to the liquid ejection unit support portion 303. “L2 in FIG. 5 indicates the length of the short side of the bottom face of the liquid supply unit 207. “L3” indicates the height (length in the vertical direction) of the liquid ejection unit support portion 303. “L4” indicates an arbitrary length extended vertically upward (in the +Z direction) along the first face 400 from the top end of the liquid ejection unit support portion 303.

As show in FIG. 5, the electrical part group 405 includes electrical parts 500 whose protruding length from the first face 400 toward the liquid storage portion 206 is comparatively short. The protruding length of the electrical parts 500 from the first face 400 toward the liquid storage portion 206 is less than or equal to the protruding length of the signal input terminal 404 from the first face 400 toward the liquid storage portion 206. The heat generation amount of the electrical parts 500 is substantially the same as the heat generation amount of the signal input terminal 404, and therefore, does not affect the liquid stored inside the liquid storage portion 206. As examples of the electrical parts 500, there are an aluminum electrolytic capacitor other than the capacitor 401 (see FIG. 4B) and a transistor other than the transistor 402 (see FIG. 4B).

Further, the length in the depth direction of the liquid supply unit 207 is greater than the length in the depth direction of the negative pressure control unit 208. The reason is to prevent the pressure loss in a case where liquid flows from becoming too great. The length in the depth direction of the negative pressure control unit 208 is substantially the same as the length in the depth direction of the liquid ejection unit support portion 303.

Here, the length of the short side of the bottom face (length in the depth direction) of the liquid supply unit 207 is taken to be L2. Further, an arbitrary length extended vertically upward (in the +Z-direction) along the first face 400 from the top end of the liquid ejection unit support portion 303 (top end of the opening accommodating the liquid supply unit 207) is taken to be L4. The protruding distance in the X-direction of the signal input terminal 404 from the first face 400 is, for example, not less than 8 mm and not more than 10 mm. In this case, on a condition that the signal input terminal 404 is provided at the position that satisfies formula 1 below, it is made possible to attach the liquid storage portion 206 to the liquid ejection unit support portion 303 without causing the liquid storage portion 206 to come into contact with the signal input terminal 404.

$$L 2 < L 4 \qquad ( formula 1 )$$

In the present embodiment, the signal input terminal 404 is provided at the position more distant than the length L2 of the short side of the bottom face of the liquid supply unit 207 in the vertically upward direction (+Z-direction) from the top end of the liquid ejection unit support portion 303.

In a case where formula 1 is satisfied, it is possible to attach the liquid storage portion 206 to the liquid ejection unit support portion 303 so that the liquid supply unit 207 does not come into contact with the signal input terminal 404 protruding considerably (8 mm or more) in the direction in which the signal input terminal 404 becomes distant from the first face 400. That is, even though the signal input terminal 404 protrudes 8 mm or more from the electrical wiring substrate 302, it is possible to prevent the liquid supply unit 207 from interfering with the signal input terminal 404 in a case where the liquid storage portion 206 is attached to the liquid ejection unit support portion 303.

Then, after the liquid storage portion 206 is attached to the liquid ejection unit support portion 303, a clearance large enough in the vertical direction (in the longitudinal direction in FIG. 5) is generated between the liquid supply unit 207 and the signal input terminal 404. Further, it is also made possible to provide the electrical parts 500 at the positions opposite to the liquid storage portion 206.

Further, as described above, the liquid storage portion 206 is provided at the position not opposite to the capacitor 401 (see FIG. 4B). In the present embodiment, the capacitor 401 (see FIG. 4B) protrudes about 10 mm from the electrical wiring substrate 302. Because of this, compared to the case where the liquid storage portion 206 and the capacitor 401 are oppose to each other, the liquid supply unit 207 does not come into contact with the capacitor 401 (see FIG. 4B) and the degree of freedom of design of the liquid supply unit 207 also improves.

In a case where the electrical part group 405 is arranged on the side opposite to the liquid storage portion 206 on the electrical wiring substrate 302, provided that the length in the conveyance direction (X-direction) of the element substrate is 15 mm, the length in the conveyance direction (X-direction) of the liquid ejection head is about 90 mm. In contrast to this, in a case where the electrical part group 405 and the liquid storage portion 206 are arranged on the same side of the electrical wiring substrate 302 as in the present embodiment, the length in the conveyance direction (X-direction) of the liquid ejection head 103 is about 50 mm. As described above, according to the configuration of the present embodiment, the liquid ejection head 103 is downsized in the conveyance direction. According to the configuration such as this, the larger the number of liquid ejection heads 103 arranged along the conveyance direction, the shorter the conveyance distance necessary for printing becomes, and therefore, it is possible to receive the merit of the downsizing of the liquid ejection head 103 in the conveyance direction.

In the following, in order to make easy the understanding of the effects in the present embodiment, explanation is given by showing an imaginary comparative example.

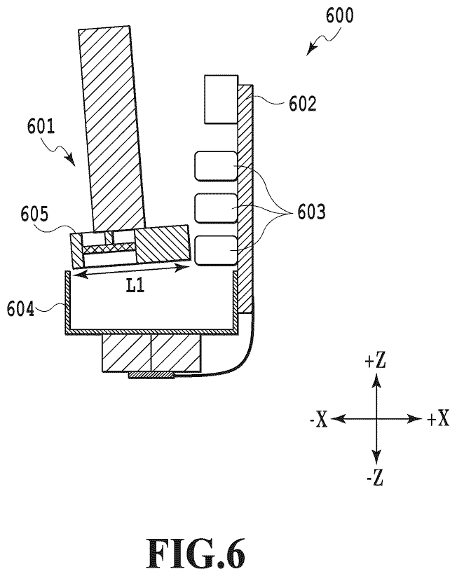

FIG. 6 is a schematic cross-sectional diagram of a liquid ejection head 600 in the comparative example. In FIG. 6, the liquid ejection head 600 is cut at the same position as the V-V line shown in FIG. 4B. Explanation of the configuration the same as or corresponding to that of the present embodiment is omitted by using the same name and different configurations are explained mainly.

As shown in FIG. 6, in the present comparative example, capacitors 603 are arranged between a liquid storage portion 601 and an electrical wiring substrate 602. Because of this, in a case where the liquid storage portion 601 is attached to a liquid supply unit support portion 604, there is a possibility that a liquid supply unit 605 comes into contact with the capacitor 603. In a case where the liquid supply unit 605 comes into contact with the capacitor 603, it may happen sometimes that the capacitor 603 is removed from the electrical wiring substrate 602 and damaged.

Further, even though it is possible to perform the attachment without the liquid supply unit 605 coming into contact with the capacitor 603, it is obliged to reduce a depth (L1) of the liquid supply unit 605 less than the depth (L2) (see FIG. 5) of the liquid supply unit 207 (see FIG. 5). With the configuration such as this, the pressure loss that occurs in a case where liquid is supplied becomes greater than the pressure loss of the present embodiment. Further, with the configuration such as this, the degree of freedom of design of the liquid storage portion 206 is reduced compared to the degree of freedom of design of the present embodiment.

The above is the explanation of the liquid ejection head 600 in the comparative example.

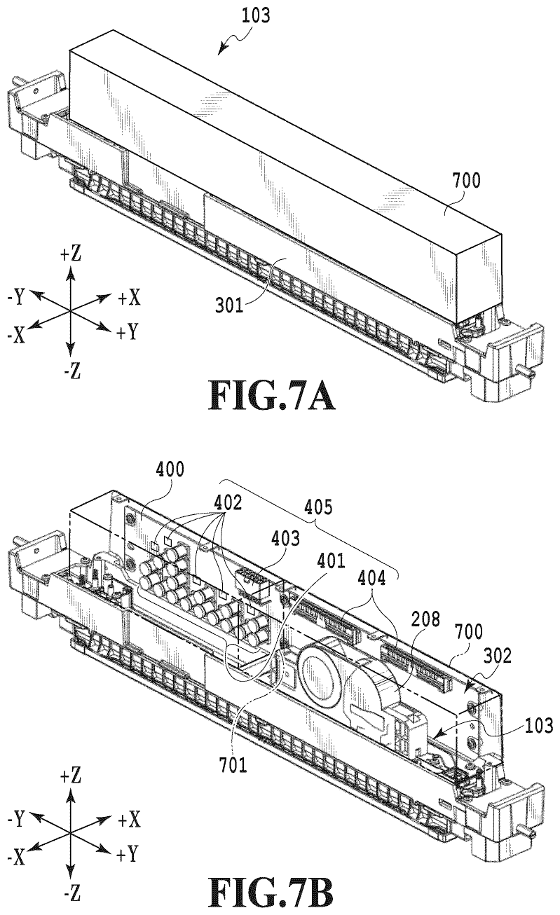

FIG. 7A is a perspective diagram of the liquid ejection head 103 on which a cover 700 is mounted in the present embodiment.

As shown in FIG. 7A, the liquid ejection head 103 comprises the cover 700 made of resin, which covers the top of the casing 301. The cover 700 is configured so as to be attachable to and detachable from the casing 301.

FIG. 7B is a transparent perspective diagram of the liquid ejection head 103 on which the cover 700 is mounted in the present embodiment.

As shown in FIG. 7B, the inside of the cover 700 covering the electrical wiring substrate 302 is divided into a first space and a second space by a partition 701. Because of this, the liquid ejection head 103 in the state where the cover 700 is attached is also divided into a first space (on the side in the −Y-direction) in which the power supply terminal 403 is provided and a second space (on the side in the +Y-direction) in which the liquid storage portion 206 is provided. In the first space, the capacitors 401, the transistors 402, the power supply terminal 403, and the signal input terminals 404 are provided. In the second space, the liquid storage portion 206 is provided.

In the present embodiment, in the state where the cover 700 is mounted on the liquid ejection head 103, the cover 700 comprises the partition 701 dividing the inside of the cover 700 into the two spaces. In the state where the cover 700 is mounted on the liquid ejection head 103, the partition 701 is located in the vicinity of the center in the longitudinal direction of the electrical wiring substrate 302. According to the configuration such as this, even in a case where the power supply terminal 403 generates heat, the heat is shut off by the partition 701. That is, it is possible to suppress the heat from moving to the side of the liquid storage portion 206 beyond the partition 701. Consequently, compared to a case where the partition 701 is not provided, it is possible to suppress ink from agglomerating inside the liquid storage portion 206.

Then, even in a case where ink leaks from the liquid storage portion 206, it is possible to suppress ink from moving to the side of the transistor 402 beyond the partition 701. Consequently, compared to a case where the partition 701 is not provided, it is further possible to suppress ink from sticking to the transistor 402.

As explained above, in the present embodiment, with the electrical wiring substrate 302 as a boundary, the capacitors 401, the transistors 402, the power supply terminal 403, the signal input terminals 404, and the liquid storage portion 206 are provided on the same side. Due to this, compared to a case where the liquid storage portion 206 is arranged on the side of the contact face with the electrical wiring substrate 302 as a boundary, it is possible to reduce the depth of the liquid ejection head 103 more than in the prior art.

Then, on the first face 400, the capacitors 401, the transistors 402, and the power supply terminal 403 are provided at the positions not opposite to the liquid storage portion 206. Consequently, compared to a case where the liquid storage portion 206 is opposite to the capacitors 401, the transistors 402, and the power supply terminal 403, reliability improves.

Consequently, according to the liquid ejection head 103 of the present embodiment, it is possible to improve reliability while downsizing the liquid ejection head 103 than in the prior art. That is, according to the liquid ejection head 103 of the present disclosure, it is possible to implement both improvement of reliability and downsizing at the same time.

### OTHER EMBODIMENTS

The above description does not limit the technical scope of the present disclosure.

The above embodiments show, as one example, the thermal liquid ejection head that ejects liquid by generating air bubbles by a heating element. However, it is also possible to apply the technique of the present disclosure to liquid ejection heads adopting the piezo method and other various liquid ejection methods.

The above embodiments show the example of the liquid ejection head in the aspect in which liquid such as ink is circulated inside the liquid ejection head, but another aspect may be accepted. For example, in a case where it is possible to cause liquid to flow from the inlet side to the outlet side within the liquid ejection head, it is not necessary to circulate liquid.

Further, in the above embodiments, liquid flows from the inlet at the end portion of the liquid ejection head toward the discharge portion at the end portion on the opposite side. However, liquid may flow from the inlet provided at the center portion of the liquid ejection head toward the discharge portions provided at both end portions.

Further, the above embodiments show the example of the so-called line head having a length corresponding to the width of a printing medium. However, it is also possible to apply the technique of the present disclosure to the so-called serial liquid ejection head that performs printing while scanning a printing medium. As an example of the serial liquid ejection head, for example, there is a liquid ejection head comprising one printing element for black ink and one printing element for color ink, respectively.

The example of the serial liquid ejection head is not limited to this. For example, a liquid ejection head in an aspect may also be accepted in which a short line head is created, in which a plurality of printing elements is arranged so as to overlap the ejection port in the ejection port array direction and whose length is shorter than the width of a printing medium, and the line head is caused to perform scanning for the printing medium. In a case where the liquid from the same inlet is supplied to a plurality of printing elements, it is possible to apply the liquid ejection head such as this.

Further, the above embodiments shows the printing apparatus with the configuration in which one liquid ejection head ejects inks of a plurality of colors, but the printing apparatus may also be configured so that the one liquid ejection head ejects ink of a single color.

Further, in the above embodiments, as examples of the electrical parts, connectors, capacitors, and transistors are given, but the electrical parts that are provided on the first face of the electrical wiring substrate may be electrical parts other than connectors, capacitors, and transistors.

According to the liquid ejection head of the present disclosure, it is possible to implement both improvement of reliability and downsizing at the same time.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-164220, filed Sep. 27, 2023 which are hereby incorporated by reference wherein in its entirety.

What is claimed is:

1. A liquid ejection head comprising:
an element substrate ejecting liquid;
an electrical wiring substrate electrically connected to the element substrate; and
a liquid storage portion configured to store liquid to be supplied to the element substrate, wherein
on a first face of the electrical wiring substrate, an electrical part generating heat in a case where power input from the outside for ejecting liquid is controlled is provided,
the liquid storage portion is provided on the first face side of the electrical wiring substrate, and
the electrical part and the liquid storage portion are not provided at positions opposite to each other in a case of being viewed from a direction perpendicular to the first face.

2. The liquid ejection head according to claim 1, wherein
the element substrate and the electrical wiring substrate are connected via a flexible wiring substrate.

3. The liquid ejection head according to claim 1, wherein
the electrical wiring substrate is a rigid substrate.

4. The liquid ejection head according to claim 1, wherein
the electrical part is a part to which a voltage of 10 V or higher is applied.

5. The liquid ejection head according to claim 4, wherein
the electrical part is at least one of a connector, a transistor, or a capacitor.

6. The liquid ejection head according to claim 1, further comprising:
a cover covering the electrical wiring substrate and the liquid storage portion, wherein
the inside of the cover has a first space in which the electrical part is provided and a second space in which the liquid storage portion is provided, both being spaces into which divided by a partition.

7. The liquid ejection head according to claim 1, wherein
the liquid ejection head is a page-wide type in which a plurality of the element substrates is arrayed.

8. The liquid ejection head according to claim 7, wherein
in the longitudinal direction of the electrical wiring substrate, the electrical part is provided on the side opposite to the side on which the liquid storage portion is provided.

9. The liquid ejection head according to claim 1, wherein
the electrical part includes a part protruding 8 mm or more in a direction in which the part becomes distant from the first face.

10. The liquid ejection head according to claim 1, wherein
the liquid storage portion includes:
a filter unit having a filter for removing foreign matter in liquid; and
a pressure control unit configured to perform pressure control of liquid having passed through the filter.

11. A liquid ejection head comprising:
an element substrate ejecting liquid;
an electrical wiring substrate electrically connected to the element substrate;
a liquid storage portion configured to store liquid to be supplied to the element substrate; and
a support portion configured to support the electrical wiring substrate and the liquid storage portion, wherein
on a first face of the electrical wiring substrate, an electrical part protruding 8 mm or more in a direction in which the electrical part becomes distant from the first face is provided,
the liquid storage portion is provided on the first face side of the electrical wiring substrate, and
the electrical part is not provided at a position closer to an upper end of an opening in the support portion in which the liquid storage portion is accommodated than a length of a short side of a bottom face in the liquid storage portion toward the vertically upward direction.

12. The liquid ejection head according to claim 11, wherein
the electrical part and the liquid storage portion are not provided at positions opposite to each other in a case of being viewed from a direction perpendicular to the first face.

13. The liquid ejection head according to claim 11, wherein
the element substrate and the electrical wiring substrate are connected via a flexible wiring substrate.

14. The liquid ejection head according to claim 11, wherein
the electrical wiring substrate is a rigid substrate.

15. The liquid ejection head according to claim 11, wherein
the electrical part is at least one of a connector, a transistor, or a capacitor.

16. The liquid ejection head according to claim 11, wherein
in the longitudinal direction of the electrical wiring substrate, the electrical part is provided on the side opposite to the side on which the liquid storage portion is provided.

17. The liquid ejection head according to claim 11, wherein
the liquid ejection head is a page-wide type in which a plurality of the element substrates is arrayed.

18. The liquid ejection head according to claim 11, wherein
the liquid storage portion includes:
a filter unit having a filter for removing foreign matter in liquid; and
a pressure control unit configured to perform pressure control of liquid having passed through the filter.

19. A liquid ejection apparatus comprising a liquid ejection head, wherein
the liquid ejection head has:
an element substrate ejecting liquid;
an electrical wiring substrate electrically connected to the element substrate; and
a liquid storage portion configured to store liquid to be supplied to the element substrate,
on a first face of the electrical wiring substrate, an electrical part generating heat in a case where power input from the outside for ejecting liquid is controlled is provided,
the liquid storage portion is provided on the first face side of the electrical wiring substrate, and
the electrical part and the liquid storage portion are not provided at positions opposite to each other in a case of being viewed from a direction perpendicular to the first face.
